(19) United States
(12) Patent Application Publication
(10) Pub. No.: US 2018/0092340 A1
(43) Pub. Date: Apr. 5, 2018

(54) PROTECTIVE WRAP FOR RECLAIMED OR NEW FISHING LURE

(71) Applicant: Courtland Tristam Babcock, III, Hilton Head, SC (US)

(72) Inventor: Courtland Tristam Babcock, III, Hilton Head, SC (US)

(21) Appl. No.: 15/729,146

(22) Filed: Oct. 10, 2017

Related U.S. Application Data
(63) Continuation of application No. 15/262,573, filed on Sep. 12, 2016, now abandoned.
Application No. 15/262,573 is a continuation of application No. 13/573,193, filed on Aug. 29, 2012, now abandoned.
(60) Provisional application No. 61/569,689, filed on Dec. 12, 2011.

(51) Int. Cl. A01K 85/00; B65B 53/02; A01K 85/01

(52) U.S. Cl. CPC A01K 85/00; B65B 53/02; A01K 85/01

(57) ABSTRACT

A skin for reclaiming a used or protecting a new fishing lure, a double-wrapped lure, and a related method of making the lure skin, and readying it and shrink wrapping it around a fishing lure, include: (a) a shrink wrappable, paper-thin polyester sheet; (b) a design printed on the polyester sheet, the polyester sheet comprising a design-free zone along its longitudinal side edges; (c) the lure skin forming a tubular shape with open opposite ends for receiving the fishing lure, the longitudinal side edges being adhered to one another, forming a central, lower seam; and (d) between about one and about four spaced apart skin holes in the central, lower seam, each hole corresponding to a belly hook eyelet of the fishing lure. This simplified abstract is not intended to limit, and should not be interpreted as limiting, the scope of the claims.

### CROSS REFERENCE TO RELATED DOCUMENT

Benefit is claimed under 35 USC 119(e) of the filing date of provisional U.S. patent application No. 61/569,689, filed on Dec. 12, 2011 and entitled “Clear and Colored Shrink Wrap to Protect and Make Fishing Jigs and Lures”.

### BACKGROUND OF THE INVENTION

### Technical Field

The present invention relates to a protective wrap for reclaiming worn fishing lures or preserving new fishing lures, more particularly a tubular-shaped, shrink wrappable polyester lure skin for reclaiming worn or protecting new fishing plugs and jigs, and a method for wrapping a fishing lure with the tubular-shaped protective lure wrap.

### Background Information

Fishermen put a great deal of thought into which brand names and types of fishing lure to purchase and use in an upcoming fishing season, using research, experience, and art. Many fishing lures are painted in brightly colored designs to resemble particular species of prey fish in order to attract both the fisherman and the type of fish the fisherman wishes to catch (here, the “targeted fish”). Fisherman will chose a lure for a particular fishing spot depending on the targeted fish, the fisherman's past experience in similar fishing locations, and sometimes on which lure is likely to impress the fisherman's fishing buddies.

Fishing tackle is quite expensive. A fisherman can pay in excess of a hundred dollars for just one fishing lure, for example. Once a fisherman's lures have been knocked around a tackle box and fishing boat, bounced around in the sand, rocks, and water, and scraped by the teeth of fish caught using the lure, the painted design on the lure, including any stickers that may have been adhered to it as part of the design, is faded and damaged. Also, conventional fishing plugs, which are typically made of wood or other lightweight, hard materials, can become waterlogged over time, rendering them useless.

Another type of fishing lure, the fishing jig, often has an expensive paint job as well. Once the pattern has worn off the fishing lure, the fisherman has lost his or her investment in it. It has been found herein that conventional finishes on fishing lures, if any, wear easily and offer no protection against abrasion. Once a fishing lure has been damaged, it is very difficult to return it to like-new condition.

Also, the typical fisherman unfortunately tends to get inordinately attached to a favorite fishing lure, thinking that the favored lure is required in order to attract fish, and that the favored lure will lead to an impressive catch, or to catching the storied “big one”. The fisherman is dismayed when he or she reels in the favorite lure to find that it has deep scratches from the teeth of the fish that got away (or didn't), or is simply worn out from repeated use.

The present invention protects new and like-new fishing lures, and extends the life of used and worn-out lures, by protecting them with the closely fitting wrap, called herein a “lure skin”. The colored and/or patterned lure skin of the present invention makes old fishing lures useful again with the easy application of the new lure skin. The design on a used lure can also be changed, if desired, by applying a new lure skin of the present invention to the surface of the used lure. Custom designed lures can be built by layering several lure skins of the present invention on a fishing lure. The present lure skins are available in a myriad of colors and sizes to fit conventional fishing lures of all lengths and sizes.

The present invention also includes a method for making a lure skin, and readying it and shrink wrapping it around a fishing lure. The method can be practiced by anyone with a lure skin of the present invention, a fishing lure, and access to a heat gun or the like.

### BRIEF SUMMARY OF THE INVENTION

The present invention is a protective wrap for reclaiming used fishing lures or for preserving new lures. The lure wrap includes: (a) a shrink wrappable, paper-thin polyester sheet, preferably polyethylene terephthalate; (b) a design printed on the polyester sheet, the polyester sheet including a design-free zone along its longitudinal side edges; (c) the lure skin forming a tubular shape with open opposite ends for receiving the fishing lure, the longitudinal side edges being adhered to one another, forming a central, lower seam of the lure skin; and (d) between about one and about four spaced apart skin holes in the central, lower seam, each hole corresponding to a belly hook eyelet of the fishing lure.

The present invention also includes a method of making a lure skin, and readying it and shrink wrapping it around a fishing lure, comprising the steps of: a) refolding the substantially planar, rectangular shaped polyester film sheet, now a lure skin, so that the lower seam forms one longitudinal edge of the lure skin; b) punching at least one skin hole in the folded lower seam, each of the skin holes corresponding to a belly hook eyelet of the fishing lure to be wrapped; c) forming the lure skin into a tubular shape and sliding the fishing lure into the tubular-shaped lure skin with each eyelet of the fishing lure extending through one of the skin holes of the lure skin; and d) applying only a sufficient amount of heat to the lure skin to cause it to shrink wrap around the fishing lure.

Advantages of the lure skin and method of the present invention include the following: 1) The lure skin protects the fishing lure it covers from the elements, wave action, and damage from fish and rocks, and prevents wooden fishing plugs from becoming water-logged; 2) The lure skin can be used to reclaim a favorite though worn-out fishing lure, thus recycling old lures and conserving funds; 3) It does not dissolve into the surrounding water and is safe for humans and the environment; 4) It allows a fisherman to apply a design, or layer designs and colors, on a plain, unpainted fishing lure; 5) The lure skin can be used to change the appearance of a fishing lure to attract a different game fish; 6) A second, and then a third or fourth, lure skin with different designs or colors can be applied over a first lure skin on a single fishing lure at the same time or once the first lure skin becomes worn, permitting a fisherman to build a unique lure; and 7) The lure skin is inexpensive and easy to apply on a fishing lure.

### BRIEF DESCRIPTION OF THE SEVERAL VIEWS OF THE DRAWINGS

A more complete understanding of the invention and its advantages will be apparent from the following detailed description taken in conjunction with the accompanying drawings, wherein examples of the invention are shown, and wherein:

FIG. 1 is a perspective view of an upper portion of a lure skin according to the present invention, shown with a fishing plug;

FIG. 2 is a perspective view of a lower portion of the lure skin according to FIG. 1, shown with a fishing plug;

FIG. 3 is a perspective view of a side of a lure skin according to the present invention, showing skin holes in the lure skin;

FIG. 4 is a perspective view of the lure skin according to FIG. 1, shown with the fishing plug partially inserted in the lure skin;

FIG. 5 is a perspective view of a lower skin portion of a lure skin according to the present invention, shown with a fishing plug inside;

FIG. 5a is a perspective view of an alternate lure skin according to the present invention, shown with a fishing jig inside;

FIG. 6 is a perspective view of a lure skin-wrapped fishing plug according to the present invention, shown with a heat gun;

FIG. 7 is a perspective view of a lure skin-wrapped fishing plug according to the present invention, with a chemiluminescent stick under the lure skin;

FIG. 8 is a perspective view of a lure skin-wrapped fishing lure according to the present invention, shown with a fringed tail;

FIG. 9 is a perspective view of a lure skin-wrapped fishing lure according to the present invention, with strands dangling from the wrapped lure; and

FIG. 10 is a flow chart of a method of making a lure skin, and readying it and shrink wrapping it around a fishing lure according to the present invention.

### DETAILED DESCRIPTION OF THE INVENTION

In the following description, like reference characters designate like or corresponding parts throughout the several views. Also, in the following description, it is to be understood that such terms as “front,” “back,” “within,” and the like are words of convenience and are not to be construed as limiting terms. Referring in more detail to the drawings, a device embodying the principles and concepts of the present invention and generally designated by the reference numeral 10 will now be described.

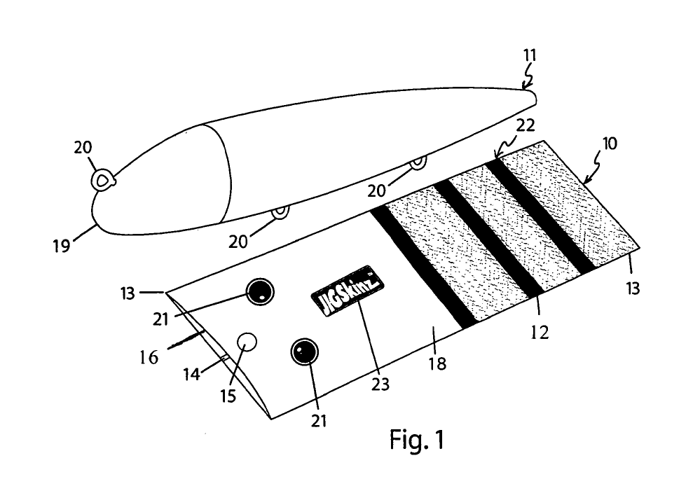

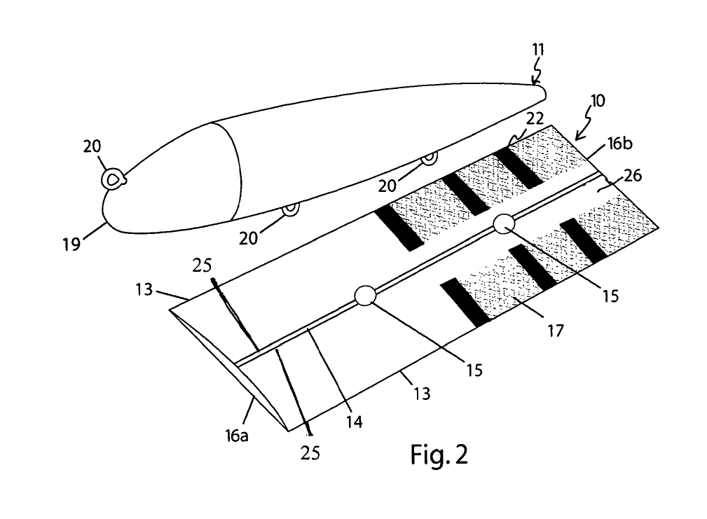

Turning first to FIG. 1, a wrap 10, also called a “lure skin” herein, for a new or used saltwater or freshwater fishing lure 11 is comprised of a polyester sheet 12 with two parallel fold lines 13, a lower seam 14, and a number of generally circular holes 15 in the shrink wrap 10. The polyester sheet 12 is folded along the two fold lines 13 so that it forms a tubular (cylindrical) shape when it is folded along the fold lines 13 and held in one hand with its opposite ends 16 open. The lure skin 10 is available in a substantially planar, rectangular-shaped form as seen in FIGS. 1 and 2, with a lower seam 14 down the approximate center of its lower skin portion 17.

As seen in FIG. 1, the upper portion 18 of the lure skin 10 preferably includes a design 22 replicating the markings of a dorsal surface of a selected bony fish species, which are in Class Osteichthyes, normally with a pair of fish eyes 21 close to the open front end 16a of the lure skin 10. Like the ventral surface of a fish, the design 22 preferably lightens toward the lower seam 14 of the lure skin 10. The design 22 is normally bilateral, with one longitudinal half of the lure skin being a mirror image of the other half, as it is on a fish. The design 22 alternatively mimics insect or amphibian prey of the targeted fish species, though the lure skin 10 may hold any effective design 22.

The thermoplastic polyester sheet material must be shrink wrappable when heated to a temperature between about 150 and about 225 degrees Fahrenheit, so that the lure skin 10 made from it shrinks onto the fishing lure substrate. Heat may be applied by blowing hot air on the lure skin 10 using a conventional hair dryer or heat gun, by heating in a steam tunnel, or any safe means of applying sufficient heat, or by dipping the lure skin 10 on the lure 11 briefly into boiling water. A suitable shrink wrapping step herein includes heating the lure skin until it starts to shrink onto the lure, and then finishing by dipping the semi-wrapped lure in boiling water. Care should be exercised. It has been seen herein that any small wrinkles remaining after shrink wrapping the lure skin 10 on the lure 11 form part of, and blend in with, the design 22.

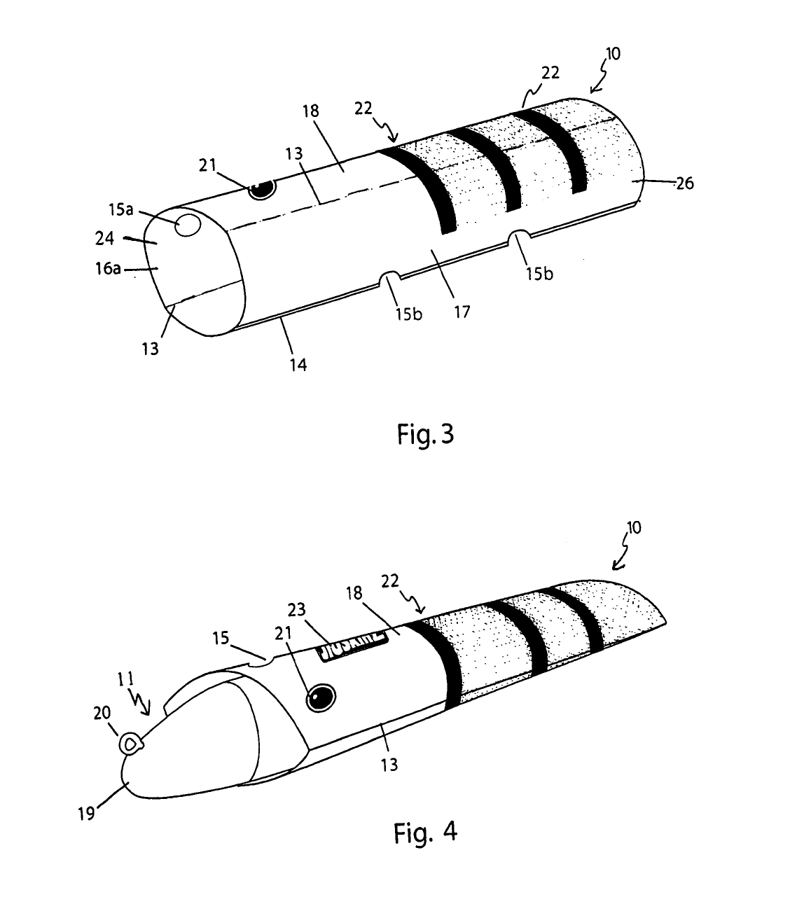

The sheet material 12 is optionally imbued with fishermen—attracting or fish—attracting chemical or natural odorizing material (material that imparts its odor) by any suitable means. Such odorizing materials include fish oil, ground-up shrimp, or any odor that is attractive to fish in the water, or fishermen (in a store, for example). The chosen scent may be coordinated with the lure skin design 22, such as fish odor with a fish design 22. The word “imbued” is meant to include combining the odorizing material with the sheet material when the sheet 12 is made, soaking the lure skin in the odorizing material, and coating or spraying the odorizing material on the lure skin 10, preferably on its inside face 24 (see FIG. 3). The odorizing material emits the chosen scent for a pre-determined period of time, which varies according to the scent, the sheet material, etc., preferably for months or years.

The polyester sheet 12 is preferably a transparent rigid polyester film, more preferably a polyethylene terepthalate, most preferably amorphous polyethylene terepthalate (APET), or polyethylene terepthalate glycol (PETG). Rigid polyester film is described chemically as amorphous polyester, copolyester. This film is not soluble in water and it is recognized as safe, nontoxic, nonhazardous, and biologically inert. It is believed that this rigid polyester film does not harm humans or fish and the environment, or interfere with performance of the lure in water. The sheet 12 can alternatively be made of a commercially available polyvinylchloride or polypropylene.

Other materials or impurities may be present in small amounts in the sheet material 12. The sheet material may be a laminate, so long as it functions as described herein. Other decorative materials, coatings, or surface ornamentation can be used on or in the sheet material herein, so long as the resulting lure wrap functions in accordance with the present invention.

The thickness of the thermoplastic film 12 must be such that the lure skin functions in accordance with the present invention. The polyester film sheet 12 is more preferably between about 1 and about 3 mils thick (most preferably 2 mils), or paper-thin. It has been found herein that if the lure skin 10 were to be any thicker or thinner, it would not shrink easily and appropriately and bond to the outer surface of the fishing lure 11 as heat is applied. A thick lure skin would likely peel away from the fishing lure and would not last as long.

It has been found herein that this preferred material of this thickness is flexible enough to permit the fishing lure 11 to be inserted, yet rigid enough so that the lure skin 10 does not have to be held in place once the fishing lure has been inserted in it and the heat is being applied. It has been found herein that once the eyelets 20 of the lure 11 have been inserted through the holes 15 in the lure skin 10, the lightweight lure skin 10 remains in position on the lure 11 while heat is being applied to the lure skin 10. The process is therefore easier and the fisherman is less likely to sustain an injury during the process.

The lure skin 10 is preferably between about 5 and about 40 centimeters, more preferably between about 10 and about 30 centimeters, in length (from one open end to the opposite end 16). The lure skins 10 are available in various lengths to fit commercially available lures, and with a variety of designs and colors.

The lower seam 14 is parallel to the fold lines 13. The lower seam 14 is formed by overlapping the two side edges 25 of the polyester sheet 12. The overlap, which forms the lower seam 14, extends from one end of the lure skin 10 to its opposite end 16. The overlapping side edges 25 are adhered to one another via application of a chemical along one of the side edges 25, which melts the preferred polyester film material 25 and bonds it together. Alternatively, an insoluble adhesive is applied along a longitudinal side edge 25 and the two longitudinal side edges 25 are adhered to one another.

The lure skin 10 has a unique set of requirements, since it is bonded to a fishing lure 11 that spends part of the time above ground and part of the time underwater. The wrapped lure 10 is subjected to unusual and sometimes harsh conditions, such as frigid ocean or lake temperatures and the sharp teeth of some game fish species. The rigid polyester film of the referred wrap herein is up to such conditions. It has been found that the lure skin-wrapped lure according to the present invention stands up to various temperature extremes, lengthy exposure to water, and scratching by sharp objects, such as fish teeth. It is easily applied to the surface of a new or used lure, and the design bears up over time.

It has been found herein that the lure skin-wrapped lure lasts longer and the design remains clear and crisp after repeated exposures to water if the design 22 is printed on the inside face of the lure skin 10. The design 22 therefore is next to the fishing lure 11 once the lure skin 10 is on the lure 11. The design 22 is thus better protected than it would be if it were printed on the outside face of the lure skin. The fishing application of the present invention is unique in that the wrapped fishing lure is underwater for long periods of time. The lure skin 10 must protect the fishing lure 11 whether it is underwater or not. The lure skin-wrapped lure also must look clear (i.e., the design 22 must be sharp and visible) out of the water and in. The variety of colors and designs on the lure skin are designed to attract the fisherman, as well as the targeted fish. The design 22 preferably illustrates a prey fish of the game fish being sought, in hopes of attracting the freshwater or marine game fish to the fishing lure. Alternatively, the design 22 can be that of the fish being sought (game fish), in which case it is more likely there to attract the fisherman than the fish. The design markings and color of the lure skin 10 correspond to the species of fish being depicted. The fisherman may catch and either release the fish caught using the lure skin-wrapped lure, or prepare the fish for eventual consumption.

The lure skin 10 is preferably transparent, so that only the design 22 on the lure skin—not the lure skin itself—is visible to the fishermen and fish in the fishing locale. The design 22, which term is meant to include a decorative pattern, is printed on the polyester sheet (no water-soluble paints), or otherwise applied as desired. “Printed” herein is meant to include printing, painting, etching, or embossing the design 22 on the lure skin 10.

The lure skins herein are useful for reclaiming worn fishing lures 11, particularly fishing jigs and plugs, or for dressing up and/or protecting plain or unfinished new or old fishing lures 11. A manufacturer can conserve funds by using a single jig blank as a base, and applying a lure skin 10 with a different design 22 on each jig blank. In this way the manufacturer ends up with a cost-effective product line of fishing jigs with a variety of designs and colors.

Water resistant stickers, glitter, flakes, or foils may also be employed in the design 22. Such stickers and foils are preferably applied on the inside face of the lure skin 10 so that they end up between the lure skin and the surface of the lure where they are protected. A logo 23 may be printed on the lure skin 10, if desired.

As seen in FIGS. 2, 3, 5, and 5a, the design 22 does not extend to the edges of the lure skin 10, and especially not to the longitudinal side edges 25. It has been found herein that the design free zone 26 on the latitudinal skin edges is beneficial because printing during manufacture is easier and because the latitudinal edges must undergo the greatest amount of shrinking around the nose 19 and tail of the torpedo shape of most lures 11, so less wrinkling of the pattern is observed if the side edge zone 26 is clear. (Lure skins are useful on one or two-piece lures that have other shapes, too.) This design-free zone 26 is also advantageous in that the design 22 will not be darker, smudged, or mismatched at the lower seam 14 and in that print ink does not interfere with adherence of the longitudinal side edges 25 to one another. This design free-zone 26 corresponds to the underbellies of many species of bony fish, which are generally lighter colored on the underbelly, with more pronounced markings on their dorsal (upper) surfaces. The design-free underbelly allows the lure skin-wrapped lure to look more realistic, which may translate to more strikes and a bigger catch. This coloration is beneficial to prey fish; the darker color on the dorsal surface (top) of a bony fish generally makes it more difficult for a predator (human or not) above the prey fish to see the fish against the dark bottom of the body of water. The lighter color on the ventral surface (beneath) of a prey fish makes is more difficult for a predator below it to see the prey fish against the light sky.

The lure skin 10 is alternatively translucent but lightly colored (light pink, blue, or yellow, for example), so the lure skin color provides a background for the design 22 on the lure skin 10. A less preferred lure skin is opaque, so that dings or other marks on a worn lure 11 do not show through the lure skin 10. Young fisherman may prefer a neon lure skin 10, or one with a familiar cartoon fish design.

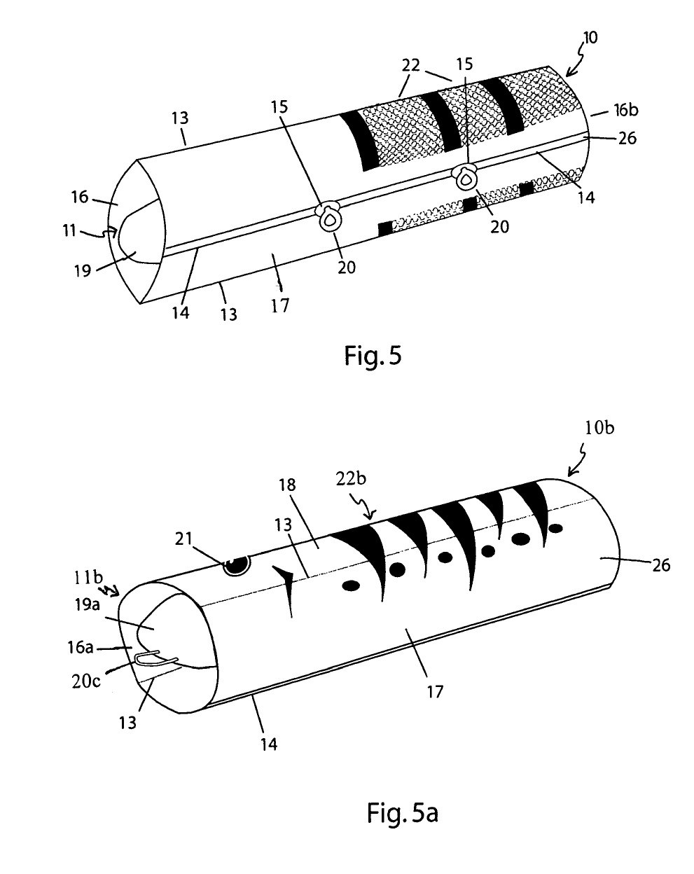

The lure skin 10 preferably includes between about one and about four spaced apart lower holes 15b in the central, lower seam 14, especially where the fishing lure 11 is a fishing plug. Each lower skin hole 15b corresponds to a belly hook eyelet 20b of the fishing lure 11, as seen in FIGS. 2, 5, and 6. To avoid accidents, belly hooks must be removed from the fishing lure 11 before the lure skin 10 is applied. The fishing hooks are placed back on the fishing plug once the lure skin 10 has been applied.

Where the fishing lure 11 does not have any hooks (e.g., a fishing jig), the lure skin 10 will not require any holes 15, as seen in FIG. 5a. Since the lure skin 10 is normally not quite as long as the fishing lure 11, the nose 19 (front end) and tail of the lure 11 are not covered by the lure skin 10. The shrink wrapped lure skin 10 fits closely around the front eyelet 20c and around the tail end of the lure. This leaves eyelets on the front 19 and/or back ends of the fishing lure 11 exposed for use, such as attachment of a fishing line.

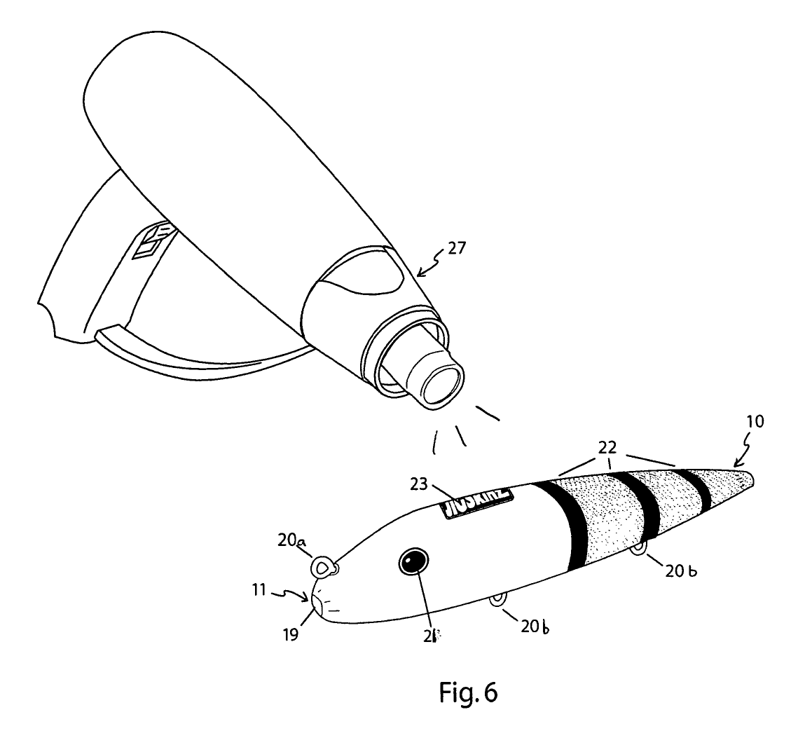

Some fishing lures include a leader eyelet 20a near the nose 19 of the lure on the upper surface of the fishing lure 11. A leader line is attached to the leader eyelet 20a when the wrapped lure is in use. A leader line is a length of line attached to a main fishing line. Before or after punching the belly skin holes 15b, the fisherman, or manufacturer, punches (or otherwise cuts) a skin hole 10a that will fit over the lure leader eyelet 20a once the lure 11 is in the lure skin 10. The leader hole 15a is preferably round so the edges of the hole 15 are less likely to rip during the process. The lure skin 10 is placed over the lure 11, with the leader hole 15a over the leader eyelet 20a, as seen in FIGS. 4 and 6, and the belly holes 15b over the belly hook eyelets 20b.

It has been found herein that making the skin holes 15 using a hand held hole punch is better because punched holes 15 have rounder, more even edges and are more consistent in size. The edges of consistent, round holes are less likely to rip around the lure hook eyelets 20 during the process. The skin holes 15 can be made in any suitable manner, though, such as using a precise knife or even scissors.

Skin holes 15 can be made during the manufacturing process, or by the fisherman using a hole punch prior to shrink wrapping. Making the holes during the manufacturing process is difficult to do when the number and location of the hooks on the fishing lure to be wrapped is not known. To make the holes, the fisherman removes the hooks from the subject lure, holds the lure 11 up to the lure skin 10, marks the location of the holes 15, and then punches the holes 15 in the central, lower seam 14. Since it has two layers (the longitudinal side edges), the central, lower seam 14 of the lure skin 10 is strong and provides support for the holes 15.

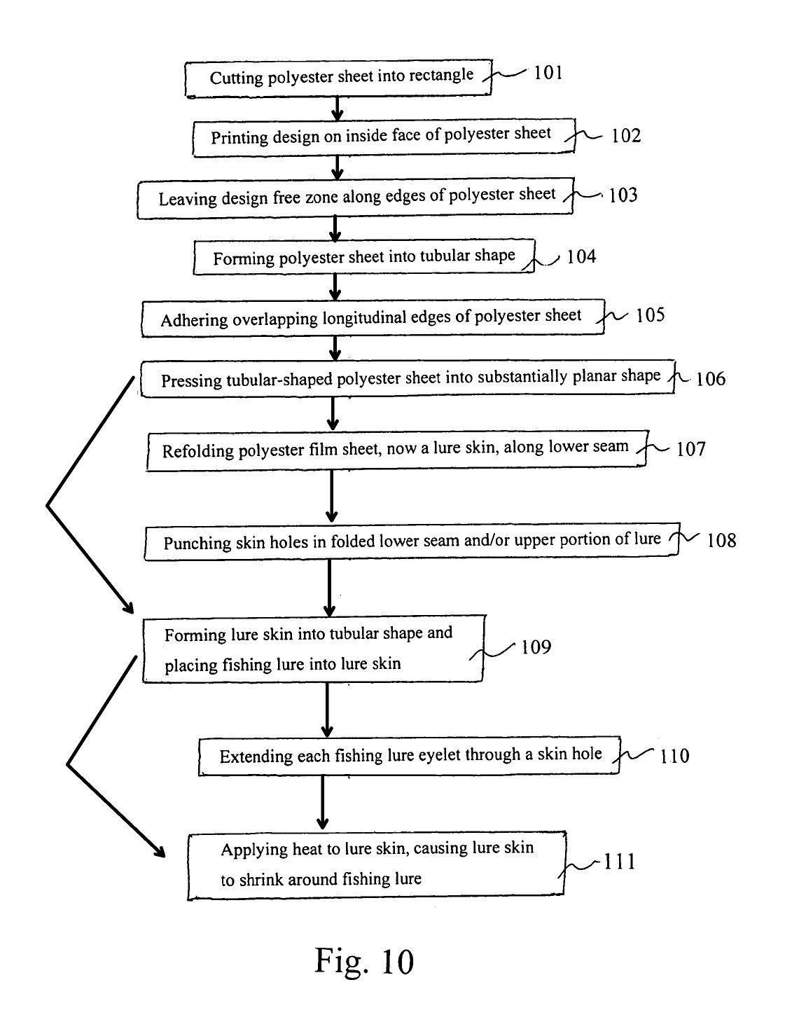

As seen in FIG. 10, a method of making a lure skin 10, and readying it and shrink wrapping it around a fishing lure 11 herein, includes the first step of: a) cutting a sheet of a polyester film 12 into a rectangular shape having a width greater than the distance around a widest part of the fishing lure 11, as seen in Block 101. By “paper-thin” is meant that the polyester film 12 has a thickness of between about 10 microns and about 200 microns. The polyester film 12 is most preferably a polyethylene terephthalate film with a thickness of between about 30 microns and about 70 microns. If the lure skin 10 is too long for the particular lure 11, the extra amount of lure skin extending beyond the front end 19 or tail end of the lure 10 is preferably trimmed off before or after heating.

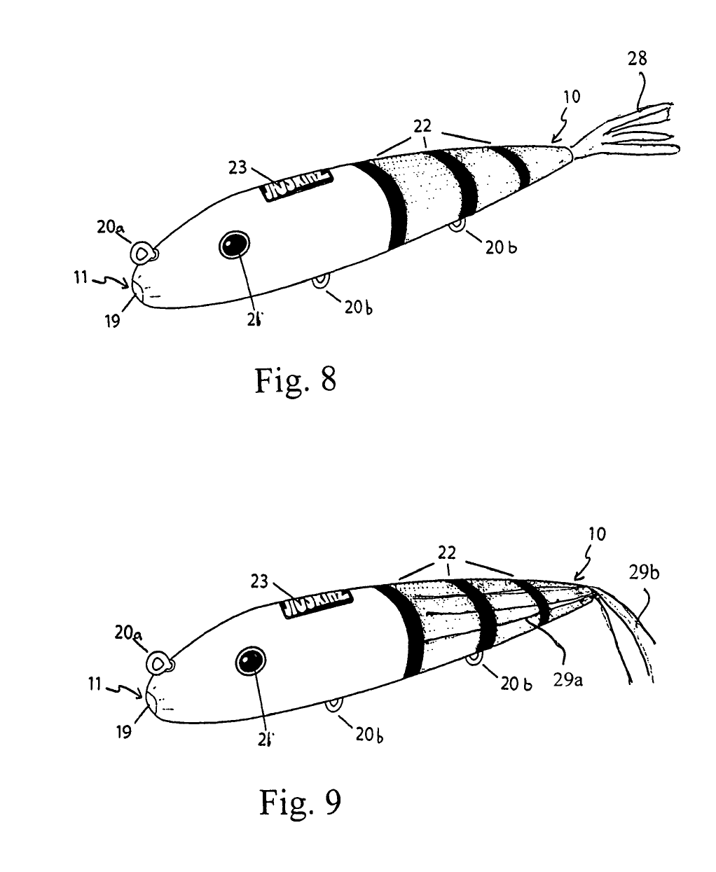

Alternatively, excess skin 28 at one or both ends of the wrapped lure can be shredded to form a fringe, which on the front end 19 conveys a squid-like appearance. FIG. 8 shows fringed excess skin 28 at the tail end of the wrapped lure. The fringed excess skin 28 on the front end 19 or the tail end of the wrapped lure generates fish-attracting movement as the wrapped lure moves.

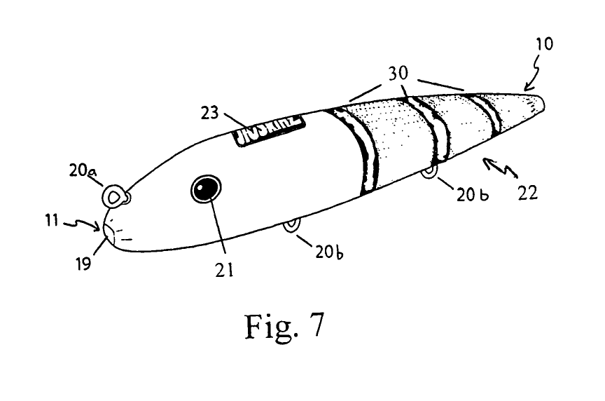

Another option is to place a transparent tube filled with chemiluminescent material, called a glow stick, on the inside face 24 of a transparent or translucent lure skin 10 prior to shrink wrapping the lure skin 10 on the fishing lure 11. The flexible chemiluminescent stick 30 is spiraled around the fishing lure 11 as seen in FIG. 7, or two chemiluminescent sticks are placed longitudinally on opposite sides of the lure 11, for example. A smaller, bracelet-sized, flexible chemiluminescent stick is used (about 1 to about 5 millimeters in diameter), not a large, rigid glow stick (e.g., for directing traffic). The light from the chemiluminescent stick 30 attracts many species of fish. The glow from the chemiluminescent stick 30 also helps in night fishing at night or dusk, or in shady areas, allowing the fisherman to more easily see the wrapped lure in the water. Where several lure skins 10 are wrapped onto a fishing lure 11 on top of one another, the chemiluminescent stick is alternatively sandwiched between the lure skins.

Yet another option is to place bright strands 29, which may be brightly colored or shiny strings, thin cords, plastic strips, or the like, on the inside face 24 of the lure skin 10 before shrink wrapping the lure skin 10 on the lure 11. Since the lure skin 10 is preferably transparent, a first portion 29a of the bright strands 29 is visible through the lure skin 10, as seen in FIG. 9. Second, end portions 29b of the bright strands 29 dangle from the front end, or the tail end 16 of the lure skin 10 as seen in FIG. 9. The strand end portions optionally include embellishments, such as sequins or small feathers. Once the lure skin 10 is shrink wrapped on the lure 11 as seen in FIG. 9, the strand end portions 29b dangle from the wrapped lure in the water, sometimes flashing in sunlight and moving in all directions, which attracts fish in the area of the wrapped lure. Where several lure skins 10 are wrapped onto a fishing lure 11 on top of one another, the first portion 29a of the strands 29 are alternatively sandwiched between the lure skins 10a, 10b.

The present method further includes the steps of: b) printing a fish design 22 on an inside face 24 of the polyester film 12, as seen in Block 102 of FIG. 10, preferably leaving a design free zone 26 along the edges of the polyester film 12, as seen in Block 103; c) forming the rectangular-shaped polyester film sheet 12 into a tubular shape with its longitudinal side edges 25 overlapping, as seen in Block 104; d) adhering the overlapping longitudinal side edges 25 to one another, so that a lower seam 14 is formed, as seen in Block 105; and e) pressing the tubular-shaped polyester film sheet 12 into a substantially planar, rectangular shape for packaging, transport, and storage, as seen in Block 106 of FIG. 10.

The step of pressing the polyester film sheet 12 into a substantially planar shape includes folding it along the two longitudinal fold lines 13 that divide the polyester sheet 12 into approximately thirds (where the middle third is the upper portion 18) or fourths, with the fold lines bordering the middle two fourths (½), which is the upper portion 18. The upper portion 18, through which the majority of the design 22 can be seen, is located above the longitudinal fold lines 13, as when the wrapped lure in a life-like, floating position (dorsal surface) generally parallel to the surface of the water. The lower skin portion 17, which includes the lower seam 14, is located below the fold lines 13 (ventral). (Some jigs are jerked through the water in a generally vertical position, though.) The fold lines 13 of the lure skin 10 are parallel to one another and to the lower seam 14 between them. The width of the lower seam 14 is preferably between about 0.5 and about 10 millimeters. The design 22 preferably includes a pair of fish eyes 21 on the upper skin portion 18.

As described herein, the preferred polyester material is rigid polyester film of chemical description amorphous polyethylene, copolyester. A preferred polyester film for use herein is polyethylene terepthalate glycol.

In a preferred tubular-shaped lure skin 10, one overlapping longitudinal side edge 25 has a width of between about 2 and about 4 millimeters, while the opposite overlapping longitudinal side edge 25 has a width of between about 4 and about 6 millimeters. It has been found herein that this seam width is wide enough not to pull apart, and narrow enough not to waste extra skin material. The longitudinal side edges 25 are preferably adhered to one another using a chemical adhesive.

The method of the present invention preferably further includes the step of: imbuing the polyester film sheet with a chosen odorizing material, the odor-imbued polyester film sheet emitting a fish-attracting or fisherman-attracting scent.

The method of the present invention preferably further includes the steps of: f) forming the lure skin 10 into a tubular shape and placing the fishing lure 11 into the tubular-shaped lure skin 10, which fits somewhat closely around the lure 11; and g) applying only a sufficient amount of heat to the lure skin 10 to cause it to shrink wrap around the fishing lure 11. In this case, the fishing lure 11 is a fishing plug with an eyelet 20c on its nose 19 for attaching a fishing line, but no belly eyelets 20b.

For a fishing lure 11 with eyelets 20, such as a fishing plug, the present method further includes the steps of: a) refolding the substantially planar, rectangular shaped polyester film sheet 12, which is now a lure skin 10, so that the lower seam 14 forms one longitudinal edge of the lure skin 10 (Block 107 of FIG. 10), as illustrated in FIG. 3; b) punching at least one skin hole 15 in the folded lower seam 14 (Block 108), each of the skin holes 15b corresponding to a belly hook eyelet 20b of the fishing lure 11 to be wrapped, as seen in FIGS. 3 and 5; c) forming the lure skin 10 into a tubular shape and placing the fishing lure 11 into the substantially close-fitting, tubular-shaped lure skin 10 (Block 109), so that each eyelet 20 of the fishing lure 11 extends through one of the holes 15 of the lure skin 10 (Block 110), as seen in FIG. 5; and d) applying only a sufficient amount of heat to the lure skin 10 to cause it to shrink wrap around the fishing lure 11 (Block 111), as depicted in FIG. 6. Where the fishing lure 11 is a jig, holes need not be punched in the lure skin 10, so the method steps shown in Blocks 107, 108 and 110 of FIG. 10 are skipped.

Where there are additional eyelets 20 on the fishing lure 11 in addition to belly hook eyelets 20b as seen in FIGS. 2 and 5, or eyelets 20c on the nose 19 or tail of the lure 11 as seen in FIG. 5a, the present method further includes the step of: punching a skin hole 15a in an upper portion 18 of the lure skin 10 corresponding to the correspondingly located eyelet 20a of the fishing lure 11. The step of punching the skin holes 15a, 15b into the lure skin 10 is preferably conducted using a hand held hole punch, although any other suitable device may be employed.

The step of applying heat to the lure skin 10 is preferably done using a hand held heat gun 27 (see FIG. 6). Preferably, the heat gun 27 is turned on and directed back and forth over the lure skin, beginning at one end of the lure skin, until the lure skin 10 shrinks around the lure 11, as seen in FIG. 6. The heat is then turned off, the wrapped lure cools, and the lure skin remains in place on the lure 11. In no event should the polyester sheet 12 be heated above the temperature of a conventional hair dryer or heat gun (above about 225 degrees Fahrenheit, for example) because accidents are more likely to occur at high temperatures and because the lure skin 10 is likely to decompose when subjected to high temperatures. A primary advantage of the present method is that it can be conducted safely and easily by fishermen of almost any age and skill level. If desired, a water resistant coating such as epoxy can be applied over the lure skin 10 once it has been wrapped on the lure 11, though such a coating is not necessary.

Once a first lure skin has been placed on a particular fishing lure and the wrapped lure is used, a second lure skin 10 can be applied over the first, worn one, and so forth. The steps of the present method can later be repeated for applying a second lure skin 10b over a first lure skin 10a of the same or a different design 22 on the same fishing lure 11. This occurs when the first lure skin 10a becomes worn, or if the fisherman simply wishes to change the design 22 on the fishing lure 11. The first lure skin 10a is preferably peeled off prior to applying the second lure skin 10, and so forth. A wide variety of patterns and colors that suit various fishing locations and conditions can be employed, even while using the same basic fishing lures.

Two or more lure skins 10 can be applied on top of one another, if desired. To do so, the steps of the method are employed. Once the first lure skin cools, the second, transparent or translucent lure skin is similarly shrink wrapped over the first lure skin using the same steps. Once a first lure skin with a first design is wrapped on the lure, a second, outermost lure skin of a complementary design or color, for example, is wrapped over the first lure skin-wrapped lure, and so forth with additional transparent or translucent lure skins 10. The additional lure skins may be tinted with a color but no pattern, for example, a pink color that will occur only along the sides of the wrapped lure, or a darker shade on the rear half than on the front half of an additional lure skin. In this manner, the fisherman can stack patterns and tints on top of one another, building his or her own unique wrapped fishing lure.

In the case of the double-wrapped lure, the lure skin-wrapped fishing lure includes: (a) a fishing lure 11 including at least one lure eyelet 20; (b) a first lure skin 10a comprised of the paper-thin rigid polyester film 12 described herein, a first design 22a being printed on an inside face 24 of the polyester film 12, the first lure skin including at least one skin hole 15, the first lure skin 10a being shrink wrapped around the fishing lure 11; and (c) a transparent second lure skin 10b comprised of the paper-thin rigid polyester film 12, a complementary second design 22b being printed on the inside face 24 of the second lure skin 10b, the second lure skin 10b including at least one skin hole 15, the second lure skin 10b being shrink wrapped over the first lure skin 10a on the fishing lure 11 with the skin hole 15 of the second lure skin 10b on top of the corresponding skin hole 15 of the first lure skin 10a. The lure skins 10a, 10b are shrink wrapped on the fishing lure 11 one after the other. Each lure eyelet 20 extends through a corresponding skin hole 15 in each lure skin 10a, 10b. Since the second skin lure 10b is transparent, a double wrapped lure has the same appearance as the wrapped lure in FIG. 6. Third and then fourth lure skins 10c can similarly be shrink wrapped on top of the second lure skin 10b.

In the double or triple wrapped lure, the preferred polyester film 12 includes the design-free zone 26 along its longitudinal side edges 25, which are adhered to one another, forming the central, lower seam 14 of the tubular-shaped lure skin 10. Here, the skin hole 15b is in the central, lower seam 14 as seen in FIG. 3. Each skin hole 15b corresponds to a belly hook eyelet 20b of the fishing lure 11, as seen in FIG. 5. Where the fishing lure 11 includes a leader eyelet 20a as seen in FIGS. 5 and 6, both of the lure skins 10a, 10b include a leader hole 15a that fits over the leader eyelet 20a.

From the foregoing it can be realized that the described device of the present invention may be easily and conveniently utilized as a wrap for a fishing lure, and a method for making a lure skin and applying it on a fishing lure. It is to be understood that any dimensions given herein are illustrative, and are not meant to be limiting.

While preferred embodiments of the invention have been described using specific terms, this description is for illustrative purposes only. It will be apparent to those of ordinary skill in the art that various modifications, substitutions, omissions, and changes may be made without departing from the spirit or scope of the invention, and that such are intended to be within the scope of the present invention as defined by the following claims. It is intended that the doctrine of equivalents be relied upon to determine the fair scope of these claims in connection with any other person's product which fall outside the literal wording of these claims, but which in reality do not materially depart from this invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. A method for dressing a fishing lure, comprising:
inserting an elongated lure body through an open end of a flat tubular thermoplastic film, the lure body having a top, a bottom, opposing sides, and at least one belly hook eyelet extending from the bottom, and the tubular film comprising opposing longitudinal folded edges, an overlapping double-layer longitudinal seam located centrally between the folded edges, an inside face between the folded edges, and a fish-replicating design printed on the inside face;
orienting the tubular film such that the longitudinal folded edges reside adjacent opposing sides of the lure body, and the fish-replicating design resides adjacent the top of the lure body, and the double-layer longitudinal seam resides adjacent the belly hook eyelet;
forming a hole in the double-layer longitudinal seam, and extending the belly hook eyelet of the lure body through the hole; and
shrink-wrapping the tubular film around the lure body such that the fish-replicating design symmetrically covers at least the top and sides of the lure body.
